(19) United States
(12) Patent Application Publication
(10) Pub. No.: US 2026/0253197 A1
(43) Pub. Date: Aug. 27, 2026

(54) FAMSYOLO NETWORK-BASED METHOD AND SYSTEM FOR DETECTING SURFACE DEFECTS OF NEW VEHICLES

(71) Applicants: East China Jiaotong University, Nanchang (CN); Institute for Smart City of Chongqing University In Liyang, Changzhou (CN); Hangzhou Institute Of Communications Planning Design&research Co., Ltd., Hangzhou (CN)

(72) Inventors: Xiangyu Wang, Perth (AU); Junbo Sun, Changzhou (CN); Hongyu Zhao, Nanchang (CN); Kan Gu, Hangzhou (CN); Jun Wang, Nanchang (CN)

(21) Appl. No.: 19/654,832

(22) Filed: Apr. 22, 2026

(30) Foreign Application Priority Data
Apr. 27, 2025 (CN) 202510535095.5

(51) Int. Cl. G06T 7/00; G06V 10/25; G06V 10/82; H04N 23/90

(52) U.S. Cl. CPC G06T 7/0004; G06V 10/25; G06V 10/82; H04N 23/90; G06T 2207/20084; G06T 2207/30156

(57) ABSTRACT

A Feature-adaptive multi-scale You Only Look Once (FamsYOLO) network-based method and system for detecting surface defects of new vehicles are provided. The method includes: acquiring images of front, rear, left, right, and top surfaces of different types of new vehicles before delivery, marking vehicle surface defects in the images, and constructing an image dataset; constructing a FamsYOLO network, where a backbone part of the FamsYOLO network is serially formed by a head DBL-3 module and an intermediate residual structure from top to bottom, and a neck part of the FamsYOLO network includes, from bottom to top in sequence, a DBL-1 module, upsampling, a first feature concatenation, a FasterC3K2 module, Reshape transformation, a second feature concatenation, a FasterC3K2 module, and a Squeeze-and-Excitation Network (SENet) module; and training the FamsYOLO network using the image dataset, where the trained FamsYOLO network is used for detecting surface defects of new vehicles.

### CROSS-REFERENCE TO RELATED APPLICATIONS

This patent application claims the benefit and priority of Chinese Patent Application No. 202510535095.5 filed with the China National Intellectual Property Administration on Apr. 27, 2025, the disclosure of which is incorporated by reference herein in its entirety as part of the present application.

### TECHNICAL FIELD

The present disclosure relates to the technical field of small target detection, and in particular, to a Feature-adaptive multi-scale You Only Look Once (FamsYOLO) network-based method and system for detecting surface defects of new vehicles.

### BACKGROUND

In the technical field of automobile manufacturing, ensuring the ex-factory quality and delivery efficiency is crucial. In automobile manufacturing, vehicle inspection is the final step before delivery. Accurate target detection and recognition of new vehicle surface conditions can prevent unqualified products from entering the market and help eliminate potential economic losses and legal disputes. Fast target detection and recognition of new vehicle surface conditions can detect quality issues in a timely manner and improve overall production efficiency. With technological development, image-based vehicle surface defect detection technologies have made remarkable progress, but still face various challenges. Especially when vehicle surface defects are small, the accuracy and speed of defect detection technologies need to be further improved.

Traditional surface defect detection methods have certain effect in recognizing large defects in vehicles, but often perform poorly in handling small defects, exhibiting difficulties in recognition. In the automobile manufacturing industry, defects on new vehicles are generally relatively small. When applied to new vehicle defect detection, traditional surface defect detection methods suffer from drawbacks such as insufficient accuracy, incomplete detection, and inadequate detection speed.

Therefore, developing a method for detecting surface defects of new vehicles that can effectively handle small targets to realize automatic surface defect detection of new vehicles before delivery has important practical significance and application value.

### SUMMARY

In view of the deficiencies of the prior art, an objective of the present disclosure is to provide a FamsYOLO network-based method and system for detecting surface defects of new vehicles, which can maintain high accuracy and robustness when defects are small, and possess fast processing speed, thereby improving detection performance when vehicle surface defects are small.

To solve the above technical problems, the technical solution of the present disclosure is as follows:

According to a first aspect, the present disclosure provides a FamsYOLO network-based method for detecting surface defects of new vehicles. The method includes the following steps:
step 1: acquiring images of front, rear, left, right, and top surfaces of different types of new vehicles before delivery, marking vehicle surface defects in the images, and constructing an image dataset;
step 2: constructing a FamsYOLO network,
where the FamsYOLO network includes three parts: a backbone part, a neck part, and an output part; the backbone part is serially formed by a head Darknetconv2d-BN-LeakyReLU (DBL)-3 module and an intermediate residual structure from top to bottom; the intermediate residual structure is serially formed by one one-layer residual module and three two-layer residual modules;
the neck part includes, from bottom to top in sequence, a DBL-1 module, upsampling, a first feature concatenation, a first FasterC3K2 module, Reshape transformation, a second feature concatenation, a second FasterC3K2 module, and a Squeeze-and-Excitation Network (SENet) module;
an output of the third two-layer residual module of the backbone part is connected to the DBL-1 module of the neck part; an output of the DBL-1 module is subjected to upsampling processing and then feature-concatenated with an output of the second two-layer residual module of the backbone part, then processed by the first FasterC3K2 module, and further feature-concatenated with a result that is obtained by subjecting an output of the first two-layer residual module of the backbone part to the Reshape transformation in the neck part; after processing by the second FasterC3K2 module and the SENet module, an output of the neck part is obtained;
the first FasterC3K2 module includes a 1×1 convolution kernel I, a feature splitting operation, a first FasterC3 module, a second first FasterC3 module, feature concatenation, and a 1×1 convolution kernel II that are connected in sequence; a part of results of the feature splitting operation is sequentially input to the first FasterC3 module and the second FasterC3 module for processing, and another part of the results of the feature splitting operation is feature-concatenated with an output of the first FasterC3 module and an output of the second FasterC3 module, and then processed by the 1×1 convolution kernel II to obtain an output of the first FasterC3K2 module;
the first FasterC3 module and the second FasterC3 module each include a 1×1 convolution kernel III, a FasterBlock module, feature concatenation, and a 1×1 convolution kernel IV that are connected in sequence; an output of the 1×1 convolution kernel III is feature-concatenated with an output of the FasterBlock module, and processed by the 1×1 convolution kernel IV to obtain the output of the first FasterC3 module and the second FasterC3 module;
the FasterBlock module includes a partial 3×3 convolution kernel, a 1×1 convolution kernel V, batch normalization (BN), a Rectified Linear Unit (ReLU) activation function, and a 1×1 convolution kernel VI that are connected in sequence; an input of the partial 3×3 convolution kernel is residually connected with an output of the 1×1 convolution kernel VI to obtain an output of the FasterBlock module;
the output part includes, from top to bottom in sequence, a first DBL-1 module, a first DBL-3 module, a second DBL-1 module, a second DBL-3 module, and a 1×1 convolution kernel VII; by processing an output feature map of the neck part, the output part is capable of recognizing vehicle surface defects in an image and displaying a category and a bounding box of a detected target in the image; and
step 3: training the FamsYOLO network using the image dataset from the step 1, where the trained FamsYOLO network is used for detecting surface defects of new vehicles.

Further, the SENet module includes global pooling, two fully connected layers, a Sigmoid activation function, and a Hadamard product.

Further, in the step 1, a gantry is set up in a vehicle production workshop, two cameras in opposite directions are mounted on a crossbeam of the gantry, and two cameras are mounted on left and right supports of the gantry, respectively; the two cameras on the crossbeam form an angle of 45° with ground, and the two cameras on the left and right supports are horizontal to the ground; the two cameras on the crossbeam and the two cameras on the left and right supports are used to acquire the images of the front, rear, left, right, and top surfaces of the different types of new vehicles, and a LabelImg tool is used for annotation to obtain annotated new vehicle images for constructing the image dataset.

Further, a comprehensive loss function of the FamsYOLO network is a sum of a confidence loss and 1.5 times a bounding box localization loss. Specifically,

$${L}_{t} = {L}_{c} + \frac{3}{2} {L}_{l}$$

$${L}_{c} = - \frac{2}{N} {\sum }_{i = 1}^{N} [ {( 1 - {p}_{i} )}^{2} {y}_{i} log ( {p}_{i} ) + {( 1 - {y}_{i} )}^{2} {p}_{i} log ( 1 - {p}_{i} ) ]$$

$${L}_{l} = 2 {\sum }_{i = 1}^{N} [ 1 - IOU + \frac{{ρ}^{2} ( {B}_{p} , {B}_{g} )}{{c}^{2}} ]$$

where Lₜ represents the comprehensive loss function, Lₗ is the bounding box localization loss, L_{c} is the confidence loss, N represents the quantity of samples, yᵢ represents a true label of sample i, pᵢ represents a predicted category probability, Bₚ represents a predicted bounding box, B_{g} represents a true bounding box, c represents a diagonal length of a minimum enclosing region containing Bₚ and B_{g}, ρ represents a Euclidean distance between center points of the predicted bounding box and the true bounding box, and IOU is an intersection over union.

Further, an image size in the image dataset is 416×416; at the start of training, network initialization parameters are set as follows: a quantity of epochs for network training is set to 850; an adaptive learning rate optimization algorithm, namely Adaptive Moment Estimation (Adam) optimizer, is adopted, with an initial learning rate of the Adam optimizer set to 0.01; the training stops when a loss variation is within ±1e-4.

Further, resolutions of the surface defects of the new vehicles are less than 32 pixels×32 pixels.

Further, for detection of the surface defects of the new vehicles, the trained FamsYOLO network achieves a mean Average Precision (mAP) higher than 60%, a parameter quantity of 4 to 5 million, and a frame rate exceeding 70 frames per second (FPS).

According to a second aspect, the present disclosure provides a FamsYOLO network-based system for detecting surface defects of new vehicles, where the system executes the steps of the method described above, and includes:
a gantry module configured to acquire surface images of new vehicles;
a FamsYOLO network configured to perform real-time target detection of surface defects of the new vehicles; and
a feedback module configured to feed back new vehicle surface conditions according to detection results of the FamsYOLO network, and if any surface defects are detected on a new vehicle, prompt an operator to send the new vehicle back for maintenance.

Compared with the prior art, the present disclosure achieves the following beneficial effects:

The method of the present disclosure constructs a FamsYOLO network, which can achieve fast and high-precision detection of surface defects of new vehicles. After detecting vehicle surface defects, it can provide the operator with vehicle surface defect information, ensuring that the operator can handle the vehicle more efficiently and guarantee the ex-factory quality and delivery efficiency of new vehicles.

In the neck part of the FamsYOLO network of the present disclosure, the FasterC3K2 module is used multiple times in combination with the SENet module, thereby greatly reducing the computational load, improving the speed of target detection, and reducing computational overhead and memory usage while ensuring model performance. Besides, the neck part can analyze input data from multiple perspectives to effectively capture more comprehensive feature information. By assigning weights to different channels, the model's attention to important channels is enhanced. The cooperation between the FasterC3K2 module and the SENet module enables the model to extract features from and recognize small targets, and effectively extract all pixel feature information in images when targets are small, thereby improving the quality of feature extraction, and enhancing the robustness of target detection and the accuracy of the model.

The present disclosure is proposed for situations where detection targets are small, has high recognition accuracy and detection efficiency for small-target detection objects, and can be used to complete various small target detection tasks.

In summary, the FamsYOLO network of the present disclosure improves feature extraction capability in the detection of small surface defects on new vehicles, achieves more comprehensive feature capture while reducing the amount of calculation, and can better handle small target detection tasks. It not only improves the accuracy of target detection, but also realizes lightweight design to reduce factory costs, while balancing accuracy, computational efficiency, and minimization of the quantity of parameters. It exhibits excellent performance in the field of new vehicle quality detection and has broad application prospects.

### BRIEF DESCRIPTION OF THE DRAWINGS

FIG. 1 is a schematic structural diagram of a FamsYOLO network according to an embodiment of the present disclosure;

FIG. 2 is a schematic structural diagram of a DBL-n module;

FIG. 3 is a schematic structural diagram of a FasterBlock module;

FIG. 4 is a schematic structural diagram of a FasterC3 module;

FIG. 5 is a schematic structural diagram of a FasterC3K2 module; and

FIG. 6 is a schematic flowchart of a process for detecting surface defects of new vehicles using the FamsYOLO network according to an embodiment of the present disclosure.

### DESCRIPTION OF EMBODIMENTS

To describe the technical problems, technical solutions, and advantages of the present disclosure more clearly, a detailed description will be provided below with reference to the accompanying drawings and embodiments. It should be noted that these embodiments are only used to illustrate the principles and application scope of the present disclosure and should not be construed as limiting the protection scope of the present disclosure.

In the description of this specification, specific features, structures, or characteristics described in different embodiments may be combined in any suitable manner in any one or more embodiments.

### Embodiment 1

This embodiment provides a FamsYOLO network-based method for detecting surface defects of new vehicles, which uses a small-target object detection algorithm, namely the FamsYOLO network, and includes the following steps:

### Step 1: Acquire a Dataset.

A camera-equipped gantry is used to acquire vehicle surface images of different models and colors. In this embodiment, the image dataset includes a total of 6200 images (mainly images of sedan-type vehicles in this embodiment, including compact cars, mid-size cars, large to mid-size cars, and full-size cars). A LabelImg tool is used to annotate the images and mark defects in the images. If an image contains a defect, the image is marked as a defective image, and bounding boxes of all recognized defects are marked; if an image contains no defects, the image is marked as a non-defective image. The image dataset is randomly divided into a training set and a test set at a ratio of 7:3. To ensure consistent image sizes when the images are input into the network model, all images are set to a size of 416×416.

### Step 2: Construct a FamsYOLO Network.

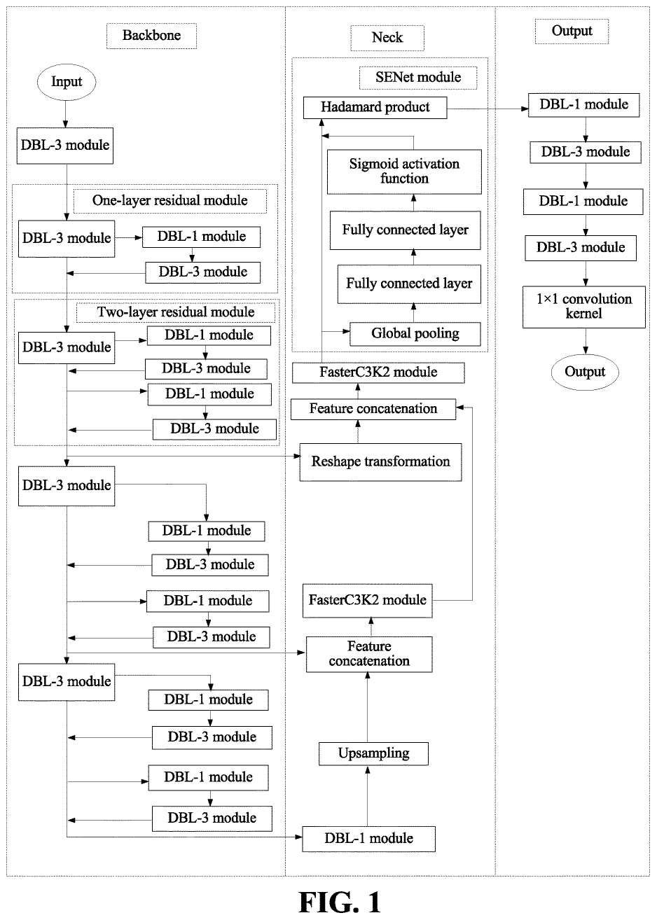

The structure of the FamsYOLO network is shown in FIG. 1, which mainly consists of three parts: a backbone part, a neck part, and an output part.

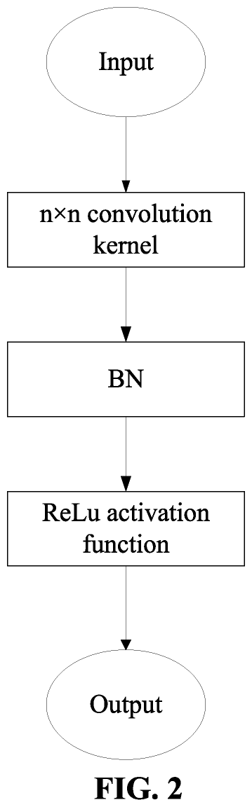

The backbone part is serially formed by a head DBL-3 module and an intermediate residual structure from top to bottom. The intermediate residual structure is serially formed by one one-layer residual module and three two-layer residual modules. For the structure of the DBL-n module, refer to FIG. 2. The DBL-n module is formed by an n×n convolution kernel, Batch Normalization (BN), and a Rectified Linear Unit (ReLU) activation function. The DBL-3 module refers to the DBL-n module where the n×n convolution kernel is a 3×3 convolution kernel, and thus is formed by a 3×3 convolution kernel, BN, and a ReLU activation function. The DBL-1 module mentioned below refers to the DBL-n module where the n×n convolution kernel is a 1×1 convolution kernel.

An input image is first processed by the backbone part. The head DBL-3 module of the backbone part performs initial feature extraction on the image and expands the quantity of channels of the image, converting the input image having a size of 416×416×3 (height×width×quantity of channels) into an initial feature map F₀ having a size of 416×416×32. Next, the initial feature map sequentially passes through the intermediate residual structure of the backbone part: the first one-layer residual module performs deep feature extraction on the initial feature map F₀ to obtain a feature map F₁ having a size of 208×208×64; then the first two-layer residual module performs feature extraction again on the feature map F₁ to obtain a feature map F₂ having a size of 104×104×128; then the second two-layer residual module performs the same feature extraction operation on the feature map F₂ to obtain a feature map F₃ having a size of 52×52×256; finally, the last two-layer residual module performs feature extraction on the feature map F₃ to obtain a feature map F₄ having a size of 26×26×512. The feature maps F₂, F₃, and F₄ are used as partial inputs for the next stage.

The feature maps F₂, F₃, and F₄ serve as inputs to the neck part. The feature map F₄ is processed by a DBL-1 module and upsampling to obtain a feature map F₅ having a size of 52×52×128. The feature map F₅ is then concatenated with the feature map F₃ to obtain a feature map F₆ having a size of 52×52×384. The feature map F₆ is then used as an input and processed by a first FasterC3K2 module for feature extraction to obtain a feature map F₁ having a size of 52×52×384.

In the first FasterC3K2 module, the feature map F₆ is first subjected to extraction by a 1×1 convolution kernel I and subjected to a feature splitting operation, dividing the feature map F₆ having a size of 52×52×384 into two equal parts Fₐ and F_{b} each having a size of 52×52×192. F_{b} serves as an input to a first FasterC3 module. In the first FasterC3 module, the feature map F_{b} is first processed by a 1×1 convolution kernel III to obtain a feature map F_{b1} having a size of 52×52×98. The feature map F_{b1} serves as an input to the FasterBlock module, and sequentially undergoes a partial 3×3 convolution kernel, a 1×1 convolution kernel V, BN, ReLU activation function, and a 1×1 convolution kernel VI in the FasterBlock module, followed by a residual connection to obtain a feature map F_{b2} having a size of 52×52×98, which is the output F_{b2} of the FasterBlock module. The feature map F_{b2} having a size of 52×52×98 is then feature-concatenated with the feature map F_{b1}, and then convolved by a 1×1 convolution kernel IV to obtain a feature map F_{c} having the same size as F_{b}, which is the output F_{c} of the first FasterC3 module.

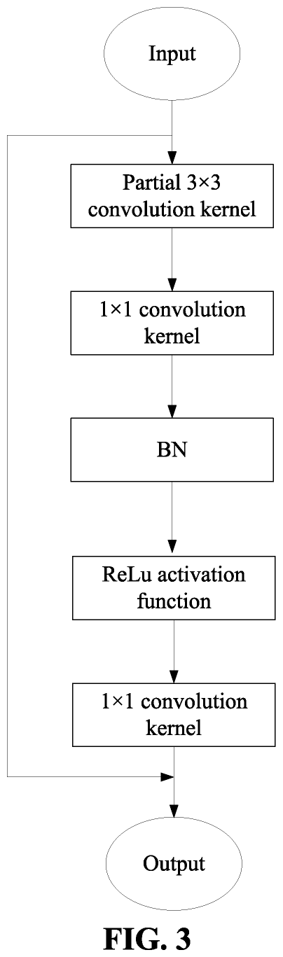

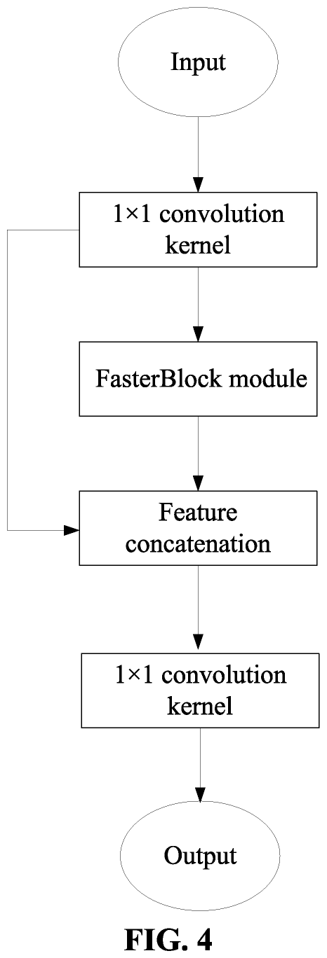

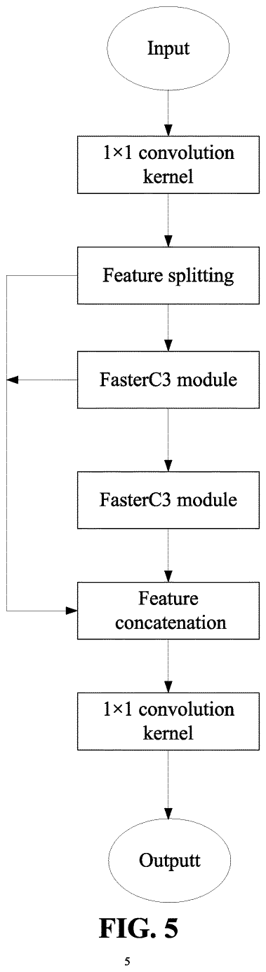

The feature map F_{c} serves as an input to a second FasterC3 module and is processed to obtain a feature map F_{d} having a size of 52×52×192. The feature maps Fₐ, F_{c}, and F_{d} are then feature-concatenated to obtain a feature map F_{c} having a size of 52×52×576. The feature map F_{c} is further processed by a 1×1 convolution kernel II to reduce the quantity of channels of the feature image, resulting in a feature map F₇ having a size of 52×52×384. The structure of the FasterBlock module is shown in FIG. 3, the structure of the FasterC3 module is shown in FIG. 4, and the structure of the FasterC3K2 module is shown in FIG. 5.

An operation formula for the partial 3×3 convolution kernel in the FasterBlock module is as follows:

$$y = {Conv}_{3 \times 3} ( x ) \times m + x \times ( 1 - m )$$

where y is an output feature map of partial convolution; Conv_{3×3} represents a 3×3 convolution operation; m is a mask, which is a learnable parameter; and x is an input feature map.

A calculation formula in the FasterC3 module is as follows:

$$F = C o n {v}_{1 \times 1} ( c o n c a t ( f , FasterBlock ( f ) ) )$$

where F is an output feature map of the FasterC3 module; Conv_{1×1} represents a 1×1 convolution operation; f is a feature map obtained after processing by the 1×1 convolution kernel III; and FasterBlock(f) is a feature map obtained after processing by the FasterBlock module.

The feature map F₂ is first subjected to a Reshape transformation to obtain a feature map F₈ having a size of 52×52×512. The feature map F₇ and F₈ are then feature-concatenated to obtain a feature map F₉ having a size of 52×52×896. The feature map F₉ is input into the second FasterC3K2 module for processing to obtain a feature map F₁₀ having a size of 52×52×896.

The SENet module includes global pooling, two fully connected layers, a Sigmoid activation function, and a Hadamard product. The feature map F₁₀ first undergoes global pooling, reducing the spatial dimensions of the feature map from 52×52×896 to 1×1×896, then passes through the first fully connected layer to reduce the quantity of channels of the feature map to 56, and then passes through the second fully connected layer to increase the quantity of channels of the feature map back to the original 896. Then normalized weights between 0 and 1 for each channel are obtained through a Sigmoid activation function. The normalized weights between 0 and 1 for each channel are then weighted into the feature map F₁₀ to obtain a feature map F₁₁, which is the Hadamard product operation in FIG. 1.

Adding the FasterC3K2 module to the neck part improves the detection accuracy and speed of the model for small targets. Meanwhile, the introduction of the SENet module enables better extraction of image features. In particular, the channel weight mechanism of the SENet module improves model accuracy without a substantial increase in parameter quantity. A calculation process of the SENet module is as follows:

First, the feature map F₁₀ undergoes global pooling, the process of which is as follows:

$${Z}_{C} = \frac{1}{52 \times 52} {\sum }_{i = 1}^{52} {\sum }_{j = 1}^{52} {u}_{c} ( i , j )$$

where u represents the feature map F₁₀; c represents a channel index, denoting a serial number of each channel; uc represents a feature of the c-th channel in the feature map F₁₀; and Z_{c} represents a global pooling result of the c-th channel.

Then, a result after the global pooling is processed by a fully connected layer and a Sigmoid activation function, the process of which is as follows:

$${S}_{c} = Sigmoid ( Dense ( Re LU ( Dense ( {Z}_{c} ) ) ) )$$

where S_{c} represents a weight of the c-th channel; Sigmoid represents the Sigmoid activation function; ReLU represents the ReLU activation function; and Dense represents the fully connected layer.

Finally, a processing result of the Sigmoid activation function is subjected to a Hadamard product operation with the feature map F₁₀ to obtain X_{c}, which is the output of the SENet module:

$${X}_{c} = {S}_{c} \times {u}_{c}$$

where X_{c} represents a result of the Hadamard product for the c-th channel.

The output part includes a first DBL-1 module, a first DBL-3 module, a second DBL-1 module, a second DBL-3 module, and a 1×1 convolution kernel VII from top to bottom. Finally, a feature map F₁₂ having a size of 52×52×255 is obtained. By processing the feature map, it is possible to recognize whether surface defects exist on a new vehicle in the image and display the category and bounding box of the detected target in the image.

Step 3: Train the FamsYOLO Network Using the Image Dataset from Step 1, where the Trained FamsYOLO Network is Used for Detecting Surface Defects of New Vehicles.

Ablation experiment: Model quality evaluation: The target detection performance is evaluated in terms of mean Average Precision (mAP), frames per second (FPS), and parameter quantity (Parameters)

To detect the effect of the SENet module on the recognition of small targets, under the constraint of the same loss function, the original network YOLO-S is combined with the FasterC3K2 module to form an Fc3YOLO network, and the Fc3YOLO network is further combined with the SENet module to form the FamsYOLO network. In addition, the Fc3YOLO network is combined with a plurality of network modules to form different networks for ablation experiments. The Fc3YOLO network is combined with a Convolutional Block Attention Module (CBAM) to form CB-Fc3YOLO; the Fc3YOLO network is combined with a Selective Kernel Network (SKNet) to form SK-Fc3YOLO; the Fc3YOLO network is combined with a Dual Attention Network (DANet) to form DA-Fc3YOLO. Different models are trained and used for target detection of new vehicle defects, and the comparison results obtained are shown in Table 1.

TABLE 1
Index Comparison of Different Models

Image dataset of different models and colors
captured by a camera-equipped gantry

| Model | mAP (%) | FPS | Parameters |
|---|---|---|---|
| FamsYOLO | 63.64 | 72 | 4.5 million |
| CB-Fc3YOLO | 44.32 | 68 | 4.3 million |
| SK-Fc3YOLO | 51.98 | 72 | 4.9 million |
| DA-Fc3YOLO | 46.71 | 64 | 4.4 million |
| Fc3YOLO | 50.18 | 66 | 4.4 million |

The results shown in Table 1 indicate that, when performing target detection on the image dataset containing vehicles of different models and colors captured by the same camera-equipped gantry, the FamsYOLO network achieves a higher mAP than CB-Fc3YOLO, SK-Fc3YOLO, DA-Fc3YOLO, and Fc3YOLO while maintaining a low parameter quantity and a high FPS. It can be concluded that the SENet module can significantly improve the recognition accuracy of the model for small targets. The combination of the SENet module and the FasterC3K2 module in the present disclosure can significantly improve the detection accuracy and detection speed for small targets.

### Embodiment 2

Based on the FamsYOLO network-based method for detecting surface defects of new vehicles, this embodiment implements detection of surface defects of new vehicles through the following steps:

### 1. Data Acquisition and Preparation Stage

### 1.1 Data Acquisition

Operation method: New vehicles pass sequentially through a camera-equipped gantry to ensure that surface images of vehicles of different models and colors are captured.

### 1.2 Data Processing

Image dataset acquisition: The collected image data is preliminarily processed, including removing obvious noise and outliers in the images, and performing image cropping and resizing to ensure the consistency and standardization of the image dataset. The collected images are divided into a training set and a test set at a ratio of 7:3.

Data augmentation: Data augmentation operations such as rotation, scaling, and flipping are performed on the training set to improve the robustness and generalization capability of the model.

### 2. Model Training Stage

### 2.1 Model Construction

A FamsYOLO network is constructed, including three parts: a backbone, a neck, and an output. The specific structure is consistent with that in Embodiment 1.

### 2.2 FamsYOLO Network Training

At the start of training, the network initialization parameters are set as follows: a quantity of epochs for network training is set to 850; an adaptive learning rate optimization algorithm, namely Adam optimizer, is adopted, with an initial learning rate of the Adam optimizer set to 0.01.

During the training process, images of the training set are input into the FamsYOLO network and read according to the storage path of the training set;

When the overall target loss function of the network no longer decreases significantly (with an error within ±1e-4), the training of the network model is regarded as stable, and the training process is completed.

In the network test phase, prepared test set images are input, and network weights obtained after training using the training set are loaded to obtain test results, thereby completing the target detection.

In view of the characteristic that the detection targets are small, the loss function of the FamsYOLO network is further optimized. A comprehensive loss function is constructed by combining the characteristics of a bounding box localization loss Lₗ and a confidence loss L_{c}, and the specific comprehensive loss function is as follows:

$${L}_{t} = {L}_{c} + \frac{3}{2} {L}_{l}$$

$${L}_{c} = - \frac{2}{N} {\sum }_{i = 1}^{N} [ {( 1 - {p}_{i} )}^{2} {y}_{i} log ( {p}_{i} ) + {( 1 - {y}_{i} )}^{2} {p}_{i} log ( 1 - {p}_{i} ) ]$$

$${L}_{l} = 2 {\sum }_{i = 1}^{N} [ 1 - IOU + \frac{{ρ}^{2} ( {B}_{p} , {B}_{g} )}{{c}^{2}} ]$$

where Lₜ represents the comprehensive loss function, N represents the quantity of samples, yᵢ represents a true label of sample i, pᵢ represents a predicted category probability, Bₚ represents a predicted bounding box, B_{g} represents a true bounding box, c represents a diagonal length of a minimum closed bounding region containing Bₚ and B_{g}, ρ represents a Euclidean distance between center points of the predicted bounding box and the true bounding box, and IOU is an intersection over union.

### 3. Processing and Analysis Stage

### 3.1 Model Deployment

Deployment: In this embodiment, four cameras are adopted, each with a resolution of 1920×1080, a frame rate of 30 FPS, and a field of view FOV (H×V×D) of 69.4°×42.5°×77° (+3°). Two cameras are mounted on the crossbeam of the gantry, and two cameras are mounted on the left and right supports of the gantry, respectively, to form a gantry module. The two cameras mounted on the crossbeam form an angle of 45° with ground, and the two cameras on the left and right supports are kept horizontal to the ground, thereby completing the preparation of the gantry module.

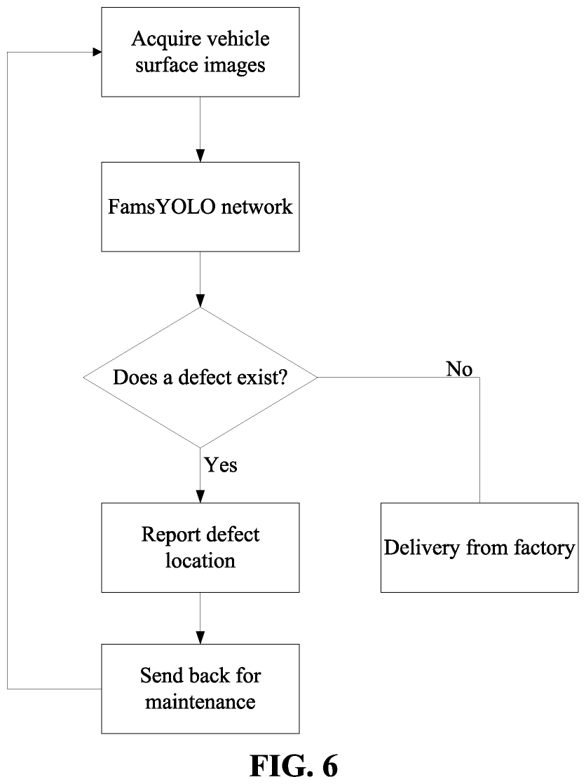

The trained FamsYOLO network is deployed to a host computer for real-time surface defect detection of new vehicles. The moving speed of new vehicles on the automobile production line is 1.5 m/s. The trained FamsYOLO network performs target detection on real-time surface images of the new vehicles transmitted by the cameras on the gantry. After surface conditions of the new vehicles are detected, the detection results are transmitted to a feedback module. If a defect is detected, the feedback module reports the defect location and prompts the operator to send the vehicle back for maintenance, for example: Defects are present on the left door, and the vehicle shall be returned for maintenance. If no defects are detected on the vehicle surface, the feedback module indicates that the vehicle surface is intact and the vehicle is qualified for ex-factory delivery (see FIG. 6).

### 3.2 Result Analysis

Model quality evaluation: The target detection performance is evaluated in terms of mean Average Precision (mAP), frames per second (FPS), and parameter quantity (Parameters).

A comparison is made between the FamsYOLO network of the present disclosure and existing methods on a dataset containing 6200 images of different vehicle models and colors collected by the same camera-equipped gantry. The comparison results show that, compared with existing high-performance target detection methods such as YOLO-S, YOLOv5s and YOLOv8, the target detection method of the present disclosure achieves lower computational load and better overall performance. The comparison results of different trained models for vehicle target detection are shown in Table 2.

TABLE 2
Index Comparison of Different Models

Dataset of different models and colors
captured by a gantry with cameras

| Model | mAP (%) | FPS | Parameters |
|---|---|---|---|
| FamsYOLO | 63.64 | 72 | 4.5 million |
| YOLOv8 | 54.68 | 62 | 4.7 million |
| YOLOv5s | 48.82 | 55 | 7.2 million |
| YOLO-S | 49.23 | 68 | 4.3 million |

The results in Table 2 indicate that when different target detection models are applied to the same image dataset collected by the camera-equipped gantry, the FamsYOLO network achieves a higher mAP than existing high-performance algorithms including YOLOv8, YOLOv5s and YOLO-S. Meanwhile, FamsYOLO maintains a high FPS with a smaller quantity of parameters. Compared with the foregoing similar target detection methods, the method of the present disclosure has significant differences, which verifies that the present disclosure exhibits excellent application performance in detecting small-sized surface defects of new vehicles.

In the present disclosure, small targets refer to defects with a resolution less than 32 pixels×32 pixels.

### Embodiment 3

Hardware devices adopted by the FamsYOLO network-based system for detecting surface defects of new vehicles in this embodiment include the following components:

Image sensor: A camera-equipped gantry is used for image acquisition, which converts optical images into electrical signals and further forms digital images.

Processor: As the core component of the present disclosure, the processor is responsible for controlling and managing the operation of the entire system, including data acquisition, data processing, image detection and other functions. The processor is required to have sufficient computing capability and parallel processing capability to meet real-time operation requirements. The processor may be in different forms such as a single-chip microcomputer, a microprocessor, and a computer to meet the demands of different application scenarios.

Memory: The memory is configured to store collected data and historical data for subsequent processing and analysis. The memory features high speed, high reliability, and good scalability to meet the requirements of long-term stable operation of the system.

Database: The database is configured to store and manage collected data, historical data, analysis results, and other information.

Network Interface: The network interface is used for data exchange and communication, and has the characteristics of high speed, high stability, and high security, so as to ensure the reliability and security of data transmission.

The processor is configured to execute computer-executable instructions. When the computer-executable instructions are executed by the processor, each step of the FamsYOLO network-based method for detecting surface defects of new vehicles is implemented.

A computer program is stored in the memory, and the computer program can be executed by the processor to implement each step of the FamsYOLO network-based method for detecting surface defects of new vehicles.

The database is configured to store and manage data of computer applications, including various data types and structures, and is applicable to each step of the FamsYOLO network-based method for detecting surface defects of new vehicles.

The network interface realizes communication and data transmission between computers. The network interface can provide various communication protocols and data transmission modes to meet communication and data transmission requirements for different application scenarios and practical demands, and is applicable to each step of the FamsYOLO network-based method for detecting surface defects of new vehicles.

### Embodiment 4

The FamsYOLO network is applied to vehicle manufacturing plants, to enhance the capability of detecting surface defects on new vehicles of different models and colors.

Deployment: The trained FamsYOLO network is deployed to a host computer in the vehicle manufacturing plant for real-time surface defect detection of new vehicles.

Quality evaluation: The mean Average Precision (mAP), frames per second (FPS), and parameter quantity (Parameters) of the target detection are calculated to evaluate target detection performance.

Performance optimization: Network model parameters are optimized online according to feedback from practical applications to improve the processing efficiency of the system.

User feedback: User feedback on target detection effects is collected to further adjust and optimize system settings.

This embodiment verifies the capability of the FamsYOLO network in detecting surface defects on new vehicles of different models and colors, and provides a new solution for surface quality inspection of new vehicles.

The present disclosure solves the problems that conventional surface quality inspection technologies for new vehicles have insufficient detection accuracy and low processing speed when applied to small target detection. The FamsYOLO network of the present disclosure realizes surface quality detection for new vehicles with small detection targets, thereby improving detection efficiency and saving computing resources.

The technical solution of the present disclosure improves target detection efficiency, avoids adverse effects caused by small detection targets, and is of great significance for improving the target detection efficiency of new vehicle quality inspection.

Matters not described in the present disclosure shall conform to the prior art.

What is claimed is:

1. A Feature-adaptive multi-scale You Only Look Once (FamsYOLO) network-based method for detecting surface defects of new vehicles, comprising following steps:
step 1: acquiring images of front, rear, left, right, and top surfaces of different types of new vehicles before delivery, marking vehicle surface defects in the images, and constructing an image dataset;
step 2: constructing a FamsYOLO network,
wherein the FamsYOLO network comprises three parts: a backbone part, a neck part, and an output part; the backbone part is serially formed by a head Darknetconv2d-BN-LeakyReLU (DBL)-3 module and an intermediate residual structure from top to bottom; the intermediate residual structure is serially formed by one one-layer residual module and three two-layer residual modules;
the neck part comprises, from bottom to top in sequence, a DBL-1 module, upsampling, a first feature concatenation, a first FasterC3K2 module, Reshape transformation, a second feature concatenation, a second FasterC3K2 module, and a Squeeze-and-Excitation Network (SENet) module;
an output of the third two-layer residual module of the backbone part is connected to the DBL-1 module of the neck part; an output of the DBL-1 module is subjected to upsampling processing and then feature-concatenated with an output of the second two-layer residual module of the backbone part, then processed by the first FasterC3K2 module, and further feature-concatenated with a result obtained by subjecting an output of the first two-layer residual module of the backbone part to the Reshape transformation in the neck part; after processing by the second FasterC3K2 module and the SENet module, an output of the neck part is obtained;
the first FasterC3K2 module comprises a 1×1 convolution kernel I, a feature splitting operation, a first FasterC3 module, a second FasterC3 module, feature concatenation, and a 1×1 convolution kernel II that are connected in sequence; a part of results of the feature splitting operation is sequentially input to the first FasterC3 module and the second FasterC3 module for processing, and another part of the results of the feature splitting operation is feature-concatenated with an output of the first FasterC3 module and an output of the second FasterC3 module, and then processed by the 1×1 convolution kernel II to obtain an output of the first FasterC3K2 module;
the first FasterC3 module and the second FasterC3 module each comprise a 1×1 convolution kernel III, a FasterBlock module, feature concatenation, and a 1×1 convolution kernel IV that are connected in sequence; an output of the 1×1 convolution kernel III is feature-concatenated with an output of the FasterBlock module, and processed by the 1×1 convolution kernel IV to obtain the output of the first FasterC3 module and the output of the second FasterC3 module;
the FasterBlock module comprises a partial 3×3 convolution kernel, a 1×1 convolution kernel V, batch normalization (BN), a Rectified Linear Unit (ReLU) activation function, and a 1×1 convolution kernel VI that are connected in sequence; an input of the partial 3×3 convolution kernel is residually connected with an output of the 1×1 convolution kernel VI to obtain an output of the FasterBlock module;
the output part comprises, from top to bottom in sequence, a first DBL-1 module, a first DBL-3 module, a second DBL-1 module, a second DBL-3 module, and a 1×1 convolution kernel VII; by processing an output feature map of the neck part, the output part is capable of recognizing vehicle surface defects in an image and displaying a category and a bounding box of a detected target in the image; and
step 3: training the FamsYOLO network using the image dataset from the step 1, wherein the trained FamsYOLO network is used for detecting surface defects of new vehicles.

2. The method according to claim 1, wherein the SENet module comprises global pooling, two fully connected layers, a Sigmoid activation function, and a Hadamard product.

3. The method according to claim 1, wherein in the step 1, a gantry is set up in a vehicle production workshop, two cameras in opposite directions are mounted on a crossbeam of the gantry, and two cameras are mounted on left and right supports of the gantry, respectively; the two cameras on the crossbeam form an angle of 45° with ground, and the two cameras on the left and right supports are horizontal to the ground; the two cameras on the crossbeam and the two cameras on the left and right supports are used to acquire the images of the front, rear, left, right, and top surfaces of the different types of new vehicles, and a LabelImg tool is used for annotation to obtain annotated new vehicle images for constructing the image dataset.

4. The method according to claim 1, wherein a comprehensive loss function of the FamsYOLO network is a sum of a confidence loss and 1.5 times a bounding box localization loss.

5. The method according to claim 1, wherein an image size in the image dataset is 416×416; at the start of training, network initialization parameters are set as follows: a quantity of epochs for network training is set to 850; an adaptive learning rate optimization algorithm, namely Adaptive Moment Estimation (Adam) optimizer, is adopted, with an initial learning rate of the Adam optimizer set to 0.01; the training stops when a loss variation is within ±1e-4.

6. The method according to claim 1, wherein resolutions of the surface defects of the new vehicles are less than 32 pixels×32 pixels.

7. The method according to claim 1, wherein for detection of the surface defects of the new vehicles, the trained FamsYOLO network achieves a mean Average Precision (mAP) higher than 60%, a parameter quantity of 4 to 5 million, and a frame rate exceeding 70 frames per second (FPS).

8. A Feature-adaptive multi-scale You Only Look Once (FamsYOLO) network-based system for detecting surface defects of new vehicles, wherein the system executes steps of the method according to claim 1, and comprises:
a gantry module configured to acquire surface images of new vehicles;
a FamsYOLO network configured to perform real-time target detection of surface defects of the new vehicles; and
a feedback module configured to feed back new vehicle surface conditions according to detection results of the FamsYOLO network, and if any surface defects are detected on a new vehicle, prompt an operator to send the new vehicle back for maintenance.
